(19) United States
(12) Patent Application Publication
(10) Pub. No.: US 2026/0202686 A1
(43) Pub. Date: Jul. 16, 2026

(54) OPHTHALMIC LENS ELEMENT WITH MASKING STRUCTURES

(71) Applicant: ESSILOR INTERNATIONAL, Charenton-Le-Pont (FR)

(72) Inventors: Hélène MAURY, Paris (FR); Delphine PASSARD, Saint-Maur-des-Fosses (FR); Justine REDON, Choisy-le-Roi (FR)

(21) Appl. No.: 19/139,322

(22) PCT Filed: Dec. 16, 2022
(86) PCT No.: PCT/IB2022/000734

§ 371 Date: Jun. 13, 2025

(51) Int. Cl. G02C 7/10; G02B 1/11; G02B 5/22; G02C 7/02

(52) U.S. Cl. CPC G02C 7/104; G02B 1/11; G02B 5/223; G02C 7/021

(57) ABSTRACT

The invention relates to a lens element intended to be worn in front of an eye of a wearer comprising: —a substrate (3) with a front face (3F) and a rear face (3R), —structure/-s to be masked (9), wherein the lens element (1) further comprises a masking medium (15) disposed upfront the structure/-s to be masked (9), the masking medium (15)—presenting absorbing properties defined by a visual absorption parameter Aᵥ within a range of 5%-25%, wherein the mean absorption is defined Aᵥ=100%−Tᵥ−R_{v*tot} and—providing the lens element (1) with, sole or in combination: o a front face visual reflectance Rᵥ<2.3%, and/or o a front face reflected colour saturation Sᵤᵥ<1.8.

### TECHNICAL FIELD

The present disclosure relates to a lens element intended to be worn in front of an eye of a person. The lens element is in particular an ophthalmic article.

The term “ophthalmic article” is specifically understood to mean a lens, corrective or otherwise, that can be used as spectacle glass, for spectacles for example, particularly sunglasses, goggles, visors or the like.

### BACKGROUND OF THE DISCLOSURE

It is known to provide lens elements with visible structures for example for customisation with a logo to make the brand visible, with structures or lines for fashion reasons or marks for mounting assistance or to equip them with structures for myopia or hyperopia control.

Such visible structures can be realized in particular by etching, laser ablation or other proceedings on a substrate.

However, it has been observed that sometimes lenses equipped with these visible structures may exhibit an unpleasant perception from an observer point of view. In particular against coloured surfaces or dark backgrounds (for example in case the spectacles equipped with such visible structures are put on a dark coloured table or someone's skin), such visible structures can easily be seen.

The present disclosure aims to provide lens elements provided with such structures having an improved perception from an observer point of view, in particular in order to achieve that such structures are less or not visible at all for an observer.

### SUMMARY OF THE DISCLOSURE

In order to achieve this goal, the present disclosure proposes a lens element intended to be worn in front of an eye of a wearer comprising:
a substrate with a front face and a rear face,
   structure/-s to be masked,
   wherein the lens element further comprises a masking medium disposed upfront the structure/-s to be masked,
   the masking medium presenting absorbing properties defined by a visual absorption parameter Aᵥ within a range of 5%-25%, wherein the mean absorption is defined Aᵥ=100%−Tᵥ−R_{v*tot} and
   providing the lens element with, sole or in combination:
      a front face visual reflectance Rᵥ≤2.3%, and/or
      a front face reflected colour saturation Sᵤᵥ<1.8.

According to further aspects taken alone or in combination relating to the above defined lens element:

The masking medium can present a front face visual reflectance Rᵥ≤1.5%.

The masking medium may present a front face reflected colour saturation of 0.1≤Sᵤᵥ≤1.2.

The masking medium can present a visual absorption parameter Aᵥ within a range within a range of 6%-20%.

The masking medium may comprise a visual absorption parameter Aᵥ within a range within a range of 8%-20%.

The masking medium can comprise a permanent colour additive.

The structure/-s to be masked is/are for example located on one of the front or rear face of the substrate, said structure/-s to be masked having for example groove and/or protuberance shape with respect to the face surface.

The structure/-s to be masked may be embedded within the substrate.

The masking medium may comprise an antireflective coating located on the front face of the lens element designed so as to define for the lens element, sole or in combination, a front face visual reflectance Rᵥ and/or a front face reflected colour saturation Sᵤᵥ as previously defined.

The lens element can further comprise a hard-coat located upfront the front face of the substrate and the absorbing properties of the masking medium are integrated in the hard coat.

The absorbing properties of the masking medium can be integrated in the substrate.

The absorbing properties of the masking medium can be integrated in the antireflective coating.

The lens element may comprise a non-engraved circular centre zone and the structure/-s to be masked is/are located outside the non-engraved circular centre zone.

The non-engraved circular centre zone can have a diameter of 3.5 mm.

The present disclosure is also related to an eyewear equipment comprising a frame that surrounds at least partially one or more of a lens element intended to be worn in front of an eye of a wearer and comprising:
a substrate with a front face and a rear face,
   structure/-s to be masked,
   wherein the lens element further comprises a masking medium disposed upfront the structure/-s to be masked,
   the masking medium presenting a visual absorption parameter Aᵥ within a range of 5%-25%, wherein the mean absorption is defined Aᵥ=100%−Tᵥ-R_{v*tot} and
   providing the lens element with, sole or in combination:
      a front face visual reflectance Rᵥ≤2.3%, and/or
a front face reflected colour saturation Sᵤᵥ<1.8.

### BRIEF DESCRIPTION OF THE DRAWINGS

Other advantages and features will become apparent upon reading the description of the following figures, among which:

FIG. 1 is a schematic rear view of a lens element according the present disclosure,

FIG. 2A is a schematic cross-sectional view of the lens element of FIG. 1,

FIG. 2B shows the lens element in an exploded cross-sectional view similar to that of FIG. 2A,

FIG. 3 shows in a graphics some examples of transmission spectra for use with a lens element according to the present disclosure,

FIG. 4 is a detailed view of a partial cross-sectional view of a lens element according to a second embodiment,

FIG. 5 is a detailed view of another partial cross-sectional view of a lens element according to a third embodiment,

FIG. 6A is a schematic cross sectional view of a lens element of according to a fourth embodiment,

FIG. 6B shows schematically in a cross sectional view a detail of FIG. 6A,

FIG. 7 is another cross-sectional view of a lens element according to a fifth embodiment,

FIG. 8 is a picture for explaining a protocol how an average visual score is obtained.

### DETAILED DESCRIPTION

On all the figures, the same elements bear the same reference numbers.

The following embodiments are only examples. Although the description refers to one or several embodiments, the invention is not limited to these embodiments. In addition, a feature described in relationship with one embodiment may also concern another embodiment even if this is not mentioned expressively. Simple features of different embodiments may also be combined to provide further realizations.

In the present description, by “front” or “rear” face of a layer or a lens element or surface, reference is made to the propagation of the rays of light towards the eye through the ophthalmic lens when an ophthalmic device bearing the ophthalmic lens is worn on a wearer's face. Thus a “front” face is always that which is farthest away to the eye of the user and therefore closest to the field of view and a “rear” face is always that which is closest to the eye of the user.

The terms “upstream” or “downstream” are used in relationship with the propagation of light from the outside, through the lens element, and towards the retina of the eye of the wearer when the lens element is worn by the wearer. Thus, a first thing (a surface, a layer, an image etc) is located upstream of a second thing when the light passes through its path towards the retina of the wearer first through the first thing and then through the second thing. From the lightpath point of view, an observer of the wearer of the lens element is always positioned upstream the lens element.

For example an image is located upstream or upfront the retina of the wearer's eye when the image is located in front of the retina between the pupil and the retina.

Conversely, a first thing is located “downstream” of a second thing when the light passes through its path towards the retina of the wearer first through the second element and then through the first element. Thus the retina of the wearer is located downstream of both, the lens element and the pupil of the wearer.

The disclosure relates to a lens element intended to be worn in front of an eye of a wearer.

In the context of the present disclosure, the term “lens element” can refer to a lens blank, an uncut optical lens, a spectacle optical lens edged to fit a specific spectacle frame, an optical filter, an optical material intended for use in an ophthalmic or optical instrument, for example lenses for optical instruments, in photography or astronomy, optical sighting lenses, ocular visors, optics of lighting systems, safety lenses, etc., or any kind of safety device including a safety glass or safety wall intended to face an individual's eye, such as a protective device, for instance safety lenses or a mask or shield or an ophthalmic lens, each of them possibly comprising a substrate, or a patch intended to be fixed on a substrate.

By way of non-limiting example, the “lens element” may be a pair of glasses, sunglasses, safety goggles, sports goggles, a contact lens, an intraocular implant, an active lens with an amplitude modulation such as a polarized lens, or with a phase modulation such as an auto-focus lens, etc.

Herein, the term “lens” means an organic or inorganic glass lens, comprising a lens substrate, which may be coated with one or more coatings of various natures.

The lens element can be a corrective lens, namely, a power lens of the spherical, cylindrical and/or addition type for an ametropic user, for treating myopia, hypermetropia, astigmatism and/or presbyopia. The lens element can have a constant power, so that it provides power as a single vision lens would do, or it can be a progressive lens having variable power.

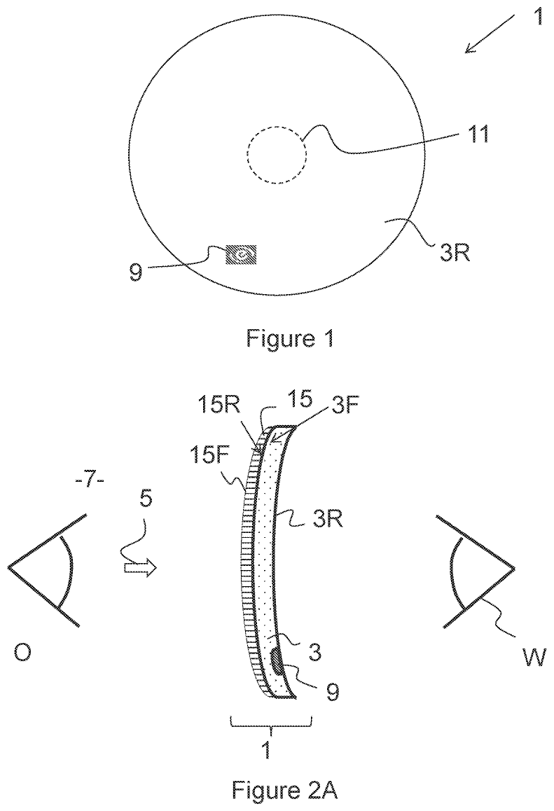

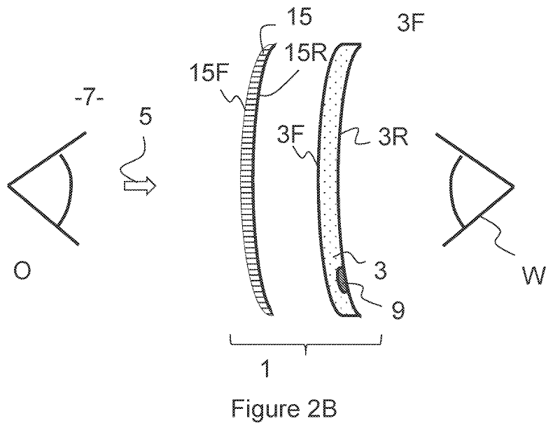

On FIGS. 1, 2A and 2B is shown a lens element 1 according to the disclosure.

As shown in FIG. 2A, the light incident on the ophthalmic article 1 is shown by the arrow 5 and an eye W represents a user/wearer of the lens element 1. The field of view 7 is thus situated on the side of the arrow 5 and the user “W” looks through the lens element 1 with his eye. Upstream the lens element 1 is also located an observer “O” who is looking in the direction of the wearer “W”.

The lens element 1 comprises a substrate 3 with a front face 3F and a rear face 3R (see also exploded view in FIG. 2B).

The substrate 3 is for example made of a plastic material, for instance a polymer substrate like a thermoplastic plastic material, such as polycarbonates and thermoplastic polyurethanes, in particular made of polyamide (PA), like nylon or a polycarbonate, polyester or TRIVEX (C) (registered trademark) or thermosetting (cross-linked) materials such as diethylene glycol bis(allylcarbonate) polymers and copolymers (in particular CR-39® from PPG Industries), thermosetting polyurethanes, polythiourethanes, preferably polythiourethane resins having a refractive index of 1.60 or 1.67, polyepoxides, polyepisulfides, such as those having a refractive index of 1.74, poly(meth)acrylates (such as PMMA) and copolymers based substrates, such as substrates comprising (meth)acrylic polymers and copolymers derived from bisphenol-A, polythio(meth)acrylates, as well as copolymers thereof and blends thereof. Preferred materials for the lens substrate are polycarbonates (PC) and diethylene glycol bis(allylcarbonate) polymers, in particular substrates made of polycarbonate. As an alternative, a PET or TAC film, or any other suitable material, may be present on the substrate, on either of its surface, for example added by lamination.

Specific examples of substrates suitable to the present invention are those obtained from thermosetting polythiourethane resins, which are marketed by the Mitsui Toatsu Chemicals company as MR series, in particular MR6®, MR7® and MR8® resins. These substrates as well as the monomers used for their preparation are especially described in the patents U.S. Pat. Nos. 4,689,387, 4,775,733, 5,059,673, 5,087,758 and 5,191,055.

The lens element 1 comprises interferential coatings that may be any coating of this kind conventionally used in the field of optics, in particular ophthalmic optics, specifically antireflective coatings deposited respectively on the front and on rear face of the lens element and designed so as to exhibit predetermined optical properties.

The interferential coatings may be deposited directly onto a bare substrate. It is preferred usually however that the main surface of the substrate be coated with one or more functional coatings improving its optical and/or mechanical properties, prior to depositing the reflective coating of the invention. These functional coatings traditionally used in optics may be, without limitation, an impact-resistant primer layer, an abrasion- and/or scratch-resistant coating (hard coat), a polarized coating, an antistatic coating, a photochromic coating, a tinted coating or a stack made of two or more of such coatings.

The impact-resistant primer coating which may be used in the present invention can be any coating typically used for improving impact resistance of a finished optical article. By definition, an impact-resistant primer coating is a coating which improves the impact resistance of the finished optical article as compared with the same optical article but without the impact-resistant primer coating.

Typical impact-resistant primer coatings are (meth)acrylic based coatings and polyurethane based coatings. In particular, the impact-resistant primer coating according to the invention can be made from a latex composition such as a poly(meth)acrylic latex, a polyurethane latex or a polyester latex.

Preferred primer compositions include compositions based on thermoplastic polyurethanes, such as those described in the patents JP 63-141001 and JP 63-87223, poly(meth)acrylic primer compositions, such as those described in the patents U.S. Pat. Nos. 5,015,523 and 6,503,631, compositions based on thermosetting polyurethanes, such as those described in the patent EP 0404111 and compositions based on poly(meth)acrylic latexes or polyurethane latexes, such as those described in the patents U.S. Pat. No. 5,316,791 and EP 0680492. Preferred primer compositions are compositions based on polyurethanes and compositions based on latexes, in particular polyurethane latexes, poly(meth)acrylic latexes and polyester latexes, as well as their combinations. In one embodiment, the impact-resistant primer comprises colloidal fillers.

Poly(meth)acrylic latexes are latexes based on copolymers essentially made of a (meth)acrylate, such as for example ethyl (meth)acrylate, butyl (meth)acrylate, methoxyethyl (meth)acrylate or ethoxyethyl (meth)acrylate, with at least one other co-monomer in a typically lower amount, such as for example styrene.

Commercially available primer compositions suitable for use in the invention include the Witcobond® 232, Witcobond® 234, Witcobond® 240, Witcobond® 242 compositions (marketed by BAXENDEN CHEMICALS), Neorez® R-962, Neorez® R-972, Neorez® R-986 and Neorez® R-9603 (marketed by ZENECA RESINS), and Neocryl® A-639 (marketed by DSM coating resins).

The thickness of the impact-resistant primer coating, after curing, typically ranges from 0.05 to 30 μm, preferably 0.2 to 20 μm and more particularly from 0.5 to 10 μm, and even better 0.6 to 5 μm or 0.6 to 3 μm, and most preferably 0.8 to 1.5 μm.

The impact-resistant primer coating is preferably in direct contact with an abrasion- and/or scratch-resistant coating.

The abrasion- and/or scratch-resistant coating may be any layer traditionally used as an anti-abrasion and/or anti-scratch coating in the field of optical lenses.

The abrasion- and/or scratch-resistant coatings are preferably hard coatings based on poly(meth)acrylates or silanes, generally comprising one or more mineral fillers intended to increase the hardness and/or the refractive index of the coating once cured.

Abrasion- and/or scratch-resistant coatings are preferably prepared from compositions comprising at least one alkoxysilane and/or a hydrolyzate thereof, obtained for example through hydrolysis with a hydrochloric acid solution and optionally condensation and/or curing catalysts.

Suitable coatings of this kind include coatings based on epoxysilanes and/or epoxysilanehydrolyzates such as those described in the patents EP 0614957, U.S. Pat. Nos. 4,211,823 and 5,015,523.

A preferred abrasion- and/or scratch-resistant coating composition is disclosed in the patent EP 0614957, in the name of the applicant. It comprises a hydrolyzate of epoxy trialkoxysilane and dialkyl dialkoxysilane, colloidal silica and a catalytic amount of an aluminum-based curing catalyst such as aluminum acetylacetonate, the rest being essentially composed of solvents traditionally used for formulating such compositions. Preferably, the hydrolyzate used is a hydrolyzate of g-glycidoxypropyltrimethoxysilane (GLYMO) and dimethyldiethoxysilane (DMDES).

The abrasion- and/or scratch-resistant coating composition may be deposited by known methods and is then cured, preferably using heat or ultraviolet radiation. The thickness of the (cured) abrasion- and/or scratch-resistant coating does generally vary from 2 to 10 mm, preferably from 3 to 5 mm.

Prior to depositing the interferential coating or other functional coatings, the surface of the article is usually submitted to a physical or chemical surface activating and cleaning pre-treatment, so as to improve the adhesion of the layer to be deposited, such as disclosed in WO 2013/013929. This pre-treatment is generally performed on the surface of an abrasion- and/or scratch-resistant coating (hard coat).

This pre-treatment is generally carried out under vacuum. It may be a bombardment with energetic species, for example an ion beam bombardment (“Ion Pre-Cleaning” or “IPC”) or an electron beam treatment, a corona treatment, an ion spallation treatment, an ultraviolet treatment or a plasma treatment under vacuum, using typically an oxygen or an argon plasma. It may also be an acid or a base surface treatment and/or a solvent surface treatment (using water or an organic solvent) with or without ultrasonic treatment. Many treatments may be combined. Thanks to these cleaning treatments, the cleanliness of the substrate surface is optimized.

By energetic species, it is meant species with an energy ranging from 1 to 300 eV, preferably from 10 to 150 eV, and more preferably from 10 to 150 eV and most preferably from 40 to 150 eV. Energetic species may be chemical species such as ions, radicals, or species such as photons or electrons.

The preferred pre-treatment is an ion bombardment, for example by using an ion gun-generated argon ion beam.

As can been seen on FIGS. 1, 2A and 2B, the rear face 3F of the substrate 3 which corresponds in the present embodiment to the rear face of the lens element 1, presents (a) structure/-s to be masked 9, for example in a peripheral region of the lens element 1, outside for example of the “COCA”, which is a non-engraved circular centre zone 11 (see FIG. 1) having for example a diameter of 3.5 mm and which means “Circle Of Clear Aperture”.

The structures to be masked 9 comprise for example diffusive structures, generally diffusing light in the overall visible light spectrum, i.e. not in a specific or selective wavelengths range, dots formed by blind holes, micro-lenses, optical Fresnel structures, optical phase shifting structures, and/or safety identity markings like a QR-code or advertising identity markings like a logo, a brand or mounting markings.

Blind holes or dots may have a diameter comprised in a range between 170 μm and 220 μm. The spacing of the centres of two neighbouring blind holes is for example comprised between 300 μm and 420 μm and a blind hole depth of less than 25 μm.

In the sense of the present disclosure, a “micro-lens” has a contour shape being inscribable in a circle having a diameter greater than or equal to 0.8 mm and smaller than or equal to 3.0 mm, preferably greater than or equal to 1.0 mm and smaller than 2.0 mm.

Concerning an optical Fresnel structure, a typical size for such structure to be masked, would be greater than or equal to 2 mm and smaller than or equal to 2.5 mm, thus smaller than the wearer eye pupil size which has been found advantageous.

Optical phase shifting structures are typically in the μm range for surficial extension and nm range for thickness.

Safety identity markings may be distributed into a rectangle of height of 17 mm and of width of 11 mm and may have similar dimensions as the above described microlenses.

A further example of a structure to be masked may be an electrical circuit like an area of conducting ITO which is engraved to form conductive tracks for example for electrochromic lens elements.

On FIG. 1, structures to be masked 9 comprises for a symbol like a logo located on the rear face 3F of the substrate 3. Structures to be masked 9 may be obtained in various ways, in particular by an engraving process, for example laser engraving or ablation, by moulding, or by additive manufacturing processes like 3D printing processes. Generally speaking, a structure to be masked 9 may be between 3-30 μm in recess or in protrusion with regard to the rear face 3F of the substrate 3.

A logo or brand for example is important for the wearer and witnesses for example origin and quality of the lens element 1 as whole.

However, as stated in the introduction, it may be unpleasant for an observer “O” to see such structure when looking in direction of the wearer “W”.

In order to prevent or at least decrease such potential unpleasant perception by the observer “O”, the lens element 1 further comprises a masking medium 15.

The masking medium 15 presents
a visual absorption parameter Aᵥ within a range of 5%-25%, wherein the mean absorption is defined Aᵥ=100%−Tᵥ−R_{*tot} and sole or in combination:
a front face visual reflectance Rᵥ≤2.3% (of front face 15F), and/or
a front face reflected colour saturation Sᵤᵥ<1.8 (of front face 15F.
In this context, Tᵥ is the luminous transmittance as defined by ISO 13666:1998:

$${T}_{V} = 100 \times \frac{{\int }_{380 nm}^{780 nm} τ ( λ ) \cdot V ( λ ) \cdot SD 65 λ \cdot d λ}{{\int }_{380 nm}^{780 nm} V ( λ ) \cdot SD 65 λ \cdot d λ} \%$$

where
τ(λ) is the spectral transmittance of the lens element
V(λ) is the spectral luminous efficiency function for daylight (see ISO/CIE 10527);
S_{D65λ}(λ) is the spectral distribution of radiation of CIE standard Illuminant D 65 (see ISO/CIE 10526).

Reflectance is defined to be the average luminous reflectance R_{V} in the visible domain such as defined in standard ISO 12311:2013 section 7.7:

The value of R_{V} in percent is obtained by calculating the ratio of the light flux reflected by the front face of the masking medium 15 φ_{R} to the incident flux φ_{I} as follows:

$${R}_{V} = 100 \times \frac{{Φ}_{R}}{{Φ}_{I}} = 100 \times \frac{{\int }_{380}^{780} ρ ( λ ) \cdot V ( λ ) \cdot {S}_{D 65} ( λ ) \cdot d λ}{{\int }_{380}^{780} V ( λ ) \cdot {S}_{D 65} ( λ ) \cdot d λ}$$

where:
   λ—is wavelength in nanometres;
   ρ(λ)—is the spectral reflectance of the front face of the masking element 15 at the wavelength λ;
   V(λ) is the relative sensitivity of the human eye, such as defined in ISO 11664-1;
   S_{D65}(λ) is the spectral power distribution of CIE standard illuminant D65, such as defined in ISO 11664-2.

The sum of the front face visual reflectance Rᵥ and the rear face visual reflectance Rᵥ is the total visual reflectance R_{v*tot}, which is determined as described above and takes into account the reflectance contributions of the front face and the rear face.

In colorimetry, the CIE 1976 L*, u*, v* colour space, commonly known by its abbreviation CIELUV, is a colour space adopted by the International Commission on Illumination (CIE) in 1976.

S_{uv*} criterion drives the perception of saturation in the CIELUV colour space.
Sᵤᵥ is the ratio of the C* in the CIELUV colour space and L*:

$${S}_{u v} = {C}_{u v}^{*} / {L}^{*}$$

In one exemplary embodiment, the masking medium 15 allows the presents a front face visual reflectance Rᵥ≤1.5%.

The masking medium 15 may present a front face reflected colour saturation in the range of 0.1≤Sᵤᵥ≤1.2.

The masking medium 15 may present in particular a visual absorption parameter Aᵥ within a range of 6%-20%, more specifically within a range within a range of 8%-20%.

The masking medium can be considered as the part of the lens element disposed upfront the structures to be masked and the front face of the masking element constitutes the front face of the lens element.

In order to achieve a visual absorption parameter Aᵥ as stated above, upfront the structures to be masked, the masking medium 15 comprises for example a permanent colour additive like a permanent dye, or a metal oxide or a coating able to reduce the transmission of an incident light beam emitted toward the front face of the lens element 1 defining absorbing properties such as interferential coatings specifically designed for this aim. Thus the absorptive property of the masking medium can be obtained for example by a specific layer made of a material like substrate 3, and/or incorporated into the substrate, or which at least can be fixed to (for example by gluing) or deposited on the substrate 3 and which incorporates such a permanent colour additive or absorptive property.

Such absorbing elements may be any absorbing elements of this kind conventionally used in the field of optics, in particular ophthalmic optics such as dyeing inks, sublimable dyes which contains a dissolved or fine-grained dispersed sublimable dye (generally three dispersion dye inks of red, blue, yellow, each being water-base ink, commercially available), selective dyes such as UV absorbing dyes as disclosed in WO2015097492, blue-violet radiation filtering dyes as disclosed in WO2013084178, IR absorbing dyes, NIR absorbing dyes, dyes useful for treating such diseases include porphyrins or a derivative thereof as disclosed in WO2013084176, and their corresponding colour balancing dyes known as providing additional absorption material configured to absorb light in a different target wavelength band to the target wavelength band of the selective filter, which helps to provide a colour balancing effect. They may be incorporated by conventional methods in the field of ophthalmic such as inkjet, dipping, sublimation, absorption onto a porous film as described in US2009004742. Said absorbing elements may comprise also interferential coatings configured to reduce the transmission of specific or not specific wavelengths of the light spectrum, such as absorbing antireflective coatings designed to absorb the above mentioned wavelengths domains and/or containing visible light absorbing metal, metal oxide layers and/or a visible light absorbing sub-stoichiometric inorganic material as disclosed in EP4095570.

Said absorbing elements can be contained in any ones of the lens element part situated upfront the structures to be masked

In order to provide the lens element 1 with a front face visual reflectance Rv and/or a front face reflected colour saturation Suv as described above, the masking medium 15 can comprise coatings deposited on the front face of the lens element 1 and designed so as to define a front face visual reflectance Rv and/or a front face reflected colour saturation Suv as described above, eventually taking in consideration the other parts of the lens element 1.

Such coatings may be any coating of this kind conventionally used in the field of optics, in particular ophthalmic optics, such as thin film device having a plurality of layers with different optical refractive indices, as antireflective coatings, holographic devices comprising a holographic recording, a predistorted rejection filter, such as a predistorted hologram on a photosensitive material deposited on a flat film of PET (polyethylene terephthalate), TAC (cellulose triacetate), COC (cyclic olefin copolymer), PU (polyurethane), or PC (polycarbonate) and later disposing it, for example by a transfer operation, on a curved substrate, photonic bandgap material, interference grating device. They may be manufactured using interferential technologies, such as thin-film technology, holographic techniques, interference recordings, or photonic bandgap materials such as liquid crystal technology, including cholesteric crystals. They may be deposited on the substrate, on the hard coating layer or on a support layer such as polymeric film of PET, TAC, COC, PU, or PC, and then disposed on an outer side of the front surface of the hard coat layer or of the substrate.

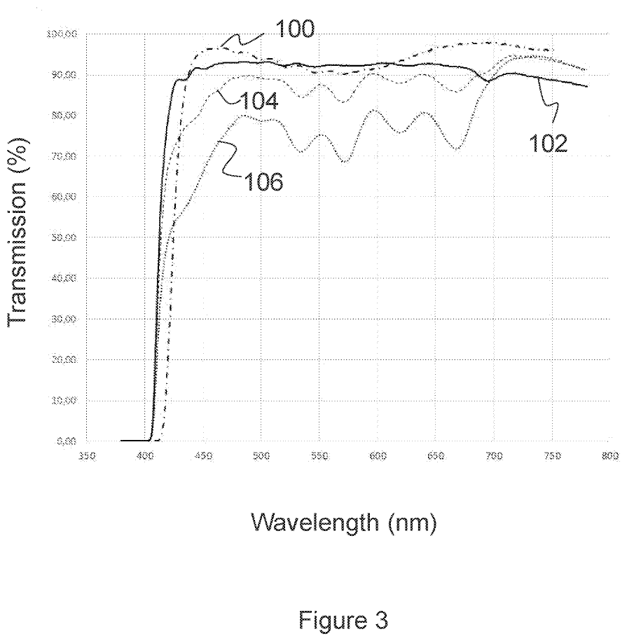

FIG. 3 shows in a graphics some examples of transmission spectra for use with a lens element 1 according to the present disclosure. The transmission is shown in function of the wavelength.

Spectrum referenced 100 presents a first example of a lens element 1 including a masking medium 15 allowing the lens element to have Tᵥ=91.90%, Rᵥ=0.57%, R_{v*tot}=1.14%, Av=6.96% and Sᵤᵥ=1.01.

Spectrum referenced 102 presents a second example of lens element 1 including a masking medium 15 allowing the lens element to have Tᵥ=92.40%, Rᵥ=1.00%, R_{v*tot}=1.8%, Av=5.8% and Sᵤᵥ=1.00.

Spectrum referenced 104 presents a third example of lens element 1 including a masking medium 15 allowing the lens element to have Tᵥ=87.21%, Rᵥ=1.0%, R_{v*tot}=1.8%, Av=10.99% and Sᵤᵥ=1.00.

Spectrum referenced 106 presents a fourth example of lens element 1 including a masking medium 15 allowing the lens element to have Tᵥ=75.33%, Rᵥ=1.00%, R_{v*tot}=1.8%, Av=22.87% and Sᵤᵥ=1.00.

As can be seen, the spectra 100, 102; 104 and 106 shown in FIG. 3 are quite flat in a range between 475 nm and 650 nm, meaning that the transmission varies less than 7.5% around a mean transmission value within that range of wavelength.

According to the specific example in FIGS. 1, 2 A and 2B, the masking medium 15 is disposed upfront the structures to be masked 9 and constitutes for the lens element 1 its front face 15F. In this particular case, the masking medium 15 may be a specific layer with a front face 15F and a rear face 15R (see in particular exploded view of lens element 1 in FIG. 2B) adhered, by gluing or lamination for example, to the front face 3F of the substrate 3.

According to a specific example, the masking medium 9 can be integrated in a hard-coat located upfront the front face on the substrate 3.

In this case, with reference to FIG. 1, the layer referenced 15 in FIG. 1 which is located upfront the front face of the substrate 3 has the properties of a hard coat (in particular protecting properties for example against scratching) as well as masking medium properties as set out above.

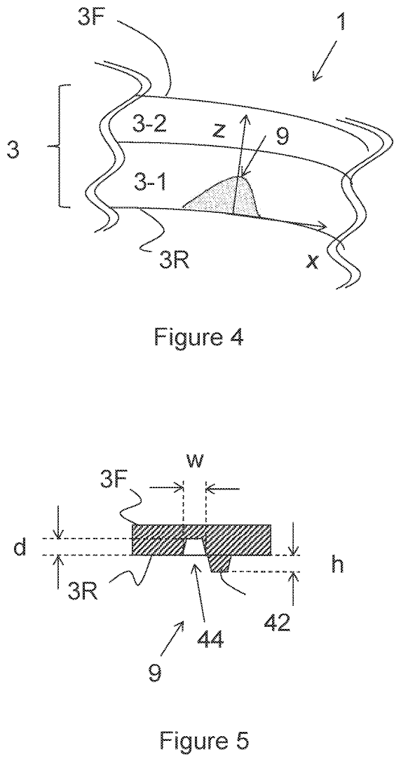

FIG. 4 relates to a further embodiment where the structures to be masked 9 are for example embedded in a layer of a multilayer substrate 3, for example when the substrate 3 comprises several layers, as shown here with sublayers 3-1 and 3-2. The structures to be masked 9 can be part of a specific optical layer of the substrate 3.

In other examples, in particular when embedded, the structures to be masked 9 may be made with a different material having a refractive index different from the refractive material forming the substrate 3.

FIG. 4 shows in a cross sectional view a part of a lens element 1 having a substrate 3 comprising a first layer 3-1 and a second layer 3-2.

In this specific example, the structures to be masked 9 are embedded in the substrate 3, in particular in layer 3-1 (which is nearest to the eye). In this case, the structure to be masked 9 has for example a refraction index which is different from the refraction index of surrounding layer 3-1 and from the upfront positioned second layer 3-2.

According to this example, but which can also be extended to the other embodiments disclosed, the structures to be masked 9 can be qualified refractive or diffractive (in particular π-Fresnel).

In particular π-Fresnel structures to be masked have discontinuities such as a discontinuous surface and/or a refractive index profile with discontinuities. A diffractive structure to be masked 9 has a phase function ‘ψ’(r) with π-phase jumps at a nominal wavelength.

More in detail, a diffractive surface such as presenting π-Fresnel structures to be masked, can be described mathematically as follows:

$$z = f ( x , y ) modulo M$$

where
f(x,y) is a continuous function and M is the step height.

$$M = j \frac{λ}{Δ n} ;$$

j being a natural number, λ being the wavelength and Δn being the difference of the refraction index of the π-Fresnel structure to be masked 9 and air.

The optical path difference (OPD) produced by such a structure to be masked 9 can be given by:

$$\begin{matrix}OPD ( x , y ) = Δ n * z \\ = Δ n * f ( x , y ) modulo ( Δ n * M ) \\ = Δ n * f ( x , y ) modulo ( j * λ )\end{matrix}$$

and the phase difference by

$$\begin{matrix}ψ ( x , y ) = \frac{2 π}{λ} * OPD ( x , y ) \\ = \frac{2 π}{λ} Δ n * f ( x , y ) modulo ( \frac{2 π}{λ} Δ n * M ) \\ = \frac{2 π}{λ} Δ n * f ( x , y ) modulo ( 2 π j )\end{matrix}$$

According to a further development, instead of a separate layer, the masking medium 9 may be integrated in the substrate 3, in particular in sublayer 3-2, which may comprise for example a permanent colour additive as disclosed above.

According to a further example shown in FIG. 5, structures to be masked 9 may comprise ribs 42 and grooves 44 which can be alternating in cross section. However, it is possible that the rear face 3R of substrate 3 shows only ribs, or only grooves, or other combinations of patterns with for example a base pattern repeating itself. The ribs 42 and grooves 44 may have at least a length of 1 mm.

The width w of such ribs 42 or grooves 44 may comprised in a range of 10-400 μm, more specifically between 50-200 μm.

The height h/depth d variation profile as shown in FIG. 5 with respect to the mean first outer surface, rear face 3F, may be is greater than 3 μm and less than 30 μm, in particular less than 15 μm.

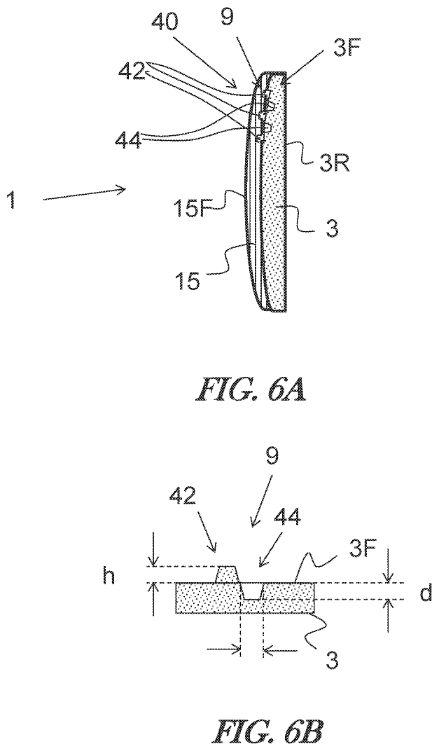

Another embodiment is presented in FIGS. 6A and 6B. FIG. 6A shows a cross section of a lens element 1 and FIG. 6B shows a view of a cross section of a detail of FIG. 6A.

FIG. 6B is quite similar to FIG. 5 and the same detailed description above with regard to FIG. 5 applies to FIG. 6B with the difference that the structures to be masked 9 are located on the front face 3F of the substrate 3.

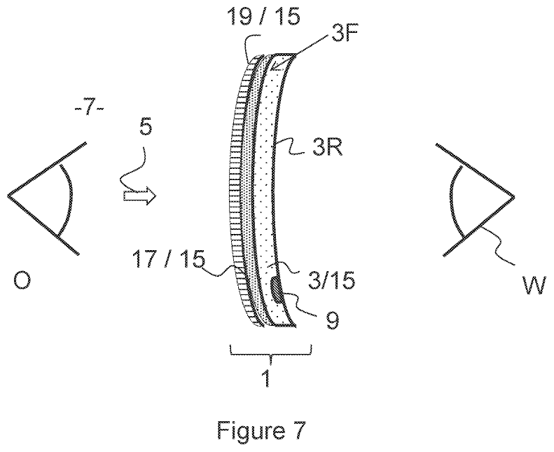

In the embodiment shown in FIG. 7, the lens elements 1 comprises a hard coat layer 17, an antireflective coating 19 located upstream the hard coat layer 17 and upfront the front face on the substrate 3. The structure to be masked 9 is present along the rear face 3R of the substrate.

In this embodiment, the whole or at least part of the absorptive properties of the masking medium may be integrated either in the hard coat layer 17 and/or in the antireflective coating 19 and/or in the substrate 3. For this reason, the first layer nearest to the observer is referenced “19/15” in order to take into account the anti-reflective function and the absorptive function of the masking means when present in the antireflective coating, in a similar way the second layer nearest to the observer is referenced “17/15” in order to take into account the hard coat function and the absorptive function of the masking means when present in the hard coat layer 17, and the substrate is referenced “3/15” to take into account the substrate function and the absorptive function of the masking means when present in the substrate.

The antireflective coating comprises for example interferential stacks designed with standard materials (for example SiO₂, ZrO₂) and simple stack structures (4 layers structure).

According to two examples of interferential antireflective stacks:

| | Thickness |
|---|---|
| Material | (nm) |
| SiO2 | 81.5 |
| ZrO2 | 67.5 |
| SiO2 | 45.8 |
| ZrO2 | 59.3 |
| Hardcoat | |

Design Suv 0.1/Rv 10%

| | Thickness |
|---|---|
| Material | (nm) |
| SiO2 | 76.7 |
| ZrO2 | 106.4 |
| SiO2 | 23.1 |
| ZrO2 | 20.6 |
| Hardcoat | |

Design Suv 1/Rv 0.8%

In order to obtain the average visual score allowing to measure to which extent structures to be masked 9 are less perceived when a specific masking medium 15 has been added to the lens element 1, a testing protocol was defined, and prototypes have been realized.

The lens elements 1 have been inspected under specific lighting conditions by two independent observers with a CIE standard using D65 illuminant, without ceiling light and in a room with black-out curtains.

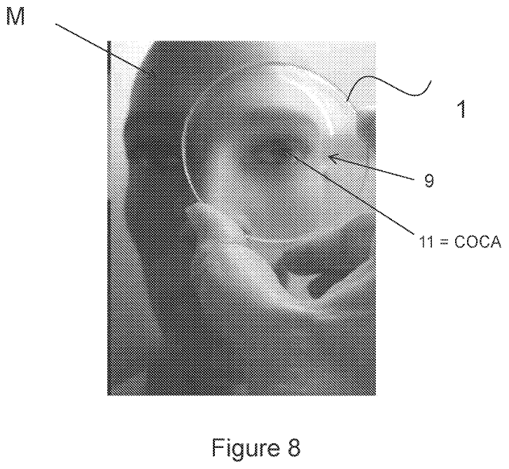

Two criteria, engraving visibility and “COCA” visibility, were analyzed on two different backgrounds: one background is black and one background is a Caucasian mannequin M as shown in FIG. 8.

A further criterion designated as “eyes visibility” was also considered with regard to Caucasian mannequin M as background as shown in FIG. 8.

The black background gives a more contrasting environment, more likely to give discriminating results. On the other hand, the mannequin M provides a more realistic environment, as if another person was observing the wearer.

The observers therefore evaluated:
the engraving visibility of the structures to be masked 9,
the visibility of COCA (circle of clear aperture) which corresponds to the non-engraved circular center zone 11
eyes visibility.

The observers used a continuous scale in a range between 1 and 5 where 1 corresponds to “less visible” and 5 to “most visible” for engraving visibility and visibility of the COCA. For eyes visibility, the observers used a continuous scale in a range between 1 and 5 where 1 corresponds to “most visible” and 5 to “less visible”. Thus in the present scale values in a range of 1-2, in particular near to 1 are the most interesting.

Thus the lower the value observed for a lens element 1, the less a structure to be masked 9 is perceived by an observer “O” looking on the wearer “W” of the lens element 1 and best the observer “O” can see the eyes of the wearer “W”.

The less visible is the COCA and the structures to be masked 9 and the best visible are the eyes, the better is the performance of a lens element 1.

With this protocol, the best achievements within a scale of 1-2 have been obtained for lens elements 1 having the features as disclosed above in the various disclosed embodiments.

1. A lens element (1) intended to be worn in front of an eye of a wearer comprising:
a substrate (3) with a front face (3F) and a rear face (3R),
structure/-s to be masked (9),
wherein the lens element (1) further comprises a masking medium (15) disposed upfront the structure/-s to be masked (9),
the masking medium (15) presenting absorbing properties defined by a visual absorption parameter Aᵥ within a range of 5%-25%, wherein the mean absorption is defined Aᵥ=100%−Tᵥ−R_{v*tot} and
providing the lens element (1) with, sole or in combination:
a front face visual reflectance Rᵥ≤2.3%, and/or
a front face reflected colour saturation Sᵤᵥ<1.8.

2. A lens element according claim 1, wherein the masking medium (15) presents a front face visual reflectance Rᵥ≤1.5%.

3. A lens element according claim 1, wherein the masking medium (15) presents a front face reflected colour saturation of 0.1≤Sᵤᵥ≤1.2.

4. A lens element according to claim 1, wherein the masking medium (15) presents a visual absorption parameter Aᵥ within a range within a range of 6%-20%.

5. A lens element according to claim 1, wherein the masking medium (15) comprises a visual absorption parameter Aᵥ within a range within a range of 8%-20%.

6. A lens element according to claim 1, wherein the masking medium (15) comprises a permanent colour additive.

7. A lens element according to claim 1, wherein the structure/-s to be masked (9) is/are located on one of the front or rear face of the substrate (3), said structure/-s to be masked (9) having groove (44) and/or protuberance (42) shape with respect to the face surface.

8. A lens element according to claim 1, wherein the structure/-s to be masked (9) is/are embedded within the substrate (3).

9. A lens element according to claim 1, wherein the masking medium comprises an antireflective coating located on the front face of the lens element (1) designed so as to define for the lens element, sole or in combination, a front face visual reflectance Rᵥ and/or a front face reflected colour saturation Sᵤᵥ as previously defined.

10. A lens element according to claim 1, wherein the lens element (1) further comprises a hard-coat (17) located upfront the front face (3F) of the substrate (3) and the absorbing properties of the masking medium (9) are integrated in the hard coat (17).

11. A lens element according to claim 1, wherein the absorbing properties of the masking medium (9) are integrated in the substrate (3).

12. A lens element according to claim 11 wherein the absorbing properties of the masking medium (9) are integrated in the antireflective coating (19).

13. A lens element according to claim 1, wherein the lens element (1) comprises a non-engraved circular centre zone (11) and the structure to be masked/-s (9) are located outside the non-engraved circular centre zone (11).

14. A lens element according to claim 13, wherein the non-engraved circular centre zone (11) has a diameter of 3.5 mm.

15. Eyewear equipment comprising a frame that surrounds at least partially one or more of a lens element (1) intended to be worn in front of an eye of a wearer and comprising:
a substrate (3) with a front face (3F) and a rear face (3R),
structure/-s to be masked (9),
wherein the lens element (1) further comprises a masking medium (15) disposed upfront the structure/-s to be masked (9),
the masking medium (15) presenting a visual absorption parameter Aᵥ within a range of 5%-25%, wherein the mean absorption is defined Aᵥ=100%−Tᵥ−R_{v*tot} and
providing the lens element (1) with, sole or in combination:
a front face visual reflectance Rᵥ≤2.3%, and/or
a front face reflected colour saturation Sᵤᵥ<1.8.
